(19) United States
(12) Patent Application Publication
(10) Pub. No.: US 2005/0207436 A1
(43) Pub. Date: Sep. 22, 2005

(54) Switching device based on aggregation of packets

(76) Inventor: Anujan Varma, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/804,674

(22) Filed: Mar. 18, 2004

(51) Int. Cl. H04L 1/00

(52) U.S. Cl. 370/412

(57) ABSTRACT

In general, in one aspect, the disclosure describes a switching device that includes a segmentation unit to receive data packets of variable size and to store the data packets as segments. The data packets received having a length greater than a maximum segment length are divided into multiple segments. A plurality of queues associated with destinations store the segments. The switching device also includes a scheduler to generate a schedule including a data path from at least one queue to an associated destination. A framer aggregates a plurality of segments to form a frame. The frame has a maximum frame length and may contain segments associated with different data packets. The segments are retrieved from the at least one queue. The switching device further includes a transmitter to transmit the frame to the associated destination. The segments within the frame are transmitted together.

### BACKGROUND

Store-and-forward devices, such as switches and routers, are used in packet networks, such as the Internet, for directing traffic at interconnection points. The store-and-forward devices include a plurality of line cards for receiving and transmitting data from/to external sources. The line cards are connected to one another via a backplane and a switching fabric. The backplane provides data paths between each line card and the switching fabric and the switching fabric provides configurable data paths between line cards. The line cards receiving data from external sources (ingress ports) receive data (packets) of various sizes. The data received are stored in queues prior to being transmitted to the appropriate line cards for transmission to external sources (egress ports). The packets include a header that identifies the destination of the packet. The packet is stored in the queue associated with that destination. The packet may also identify a priority for the data and the ingress port may also include queues for the various priorities.

The ingress ports send requests for transmitting data to a scheduler within the switching fabric. The scheduler generates grants for the queues that should transmit packets therefrom. The packets are switched through a crossbar switching matrix in batches. A batch consists of at most one packet selected from each input port. Thus, no more than one of the packets is destined for each output port. The packets in a batch are transferred in parallel across the crossbar switching matrix. While the packets from a scheduled batch are being transferred through the crossbar, the scheduler can select the packets to form the next batch, so that the transmission of the new batch of packets can start as soon as transmission of the current batch ends. At the end of each batch of packets, the fabric scheduler re-configures the crossbar switching matrix so as to connect each input port to the output port where its next packet is destined to.

Because the packets are transferred in batches, the switching paths in the crossbar switching matrix is kept unchanged for the duration of the longest packet being transferred across the crossbar in that batch. When the packets are of variable size (as is the case for packets generated by most network protocols in the industry), this results in wasted bandwidth. For example, when a 50-byte packet and a 1500-byte packet are part of the same batch, the crossbar is be maintained in the same configuration for the duration of the 1500-byte packet, and only 1/30^{th} of the bandwidth of the path is used by the 50-byte packet.

One solution for avoiding the inefficiency caused by variable-size packets is to divide the packets into fixed-size units before switching through the crossbar switching fabric, and combine the fragments into the original packet at the output of the fabric. The packet fragments switched through the crossbar are called “segments” or “cells”. The fabric scheduler selects at most one cell from each input port to form a batch, such that the destination port numbers associated with the cells in the same batch are distinct. The cells in the same batch are then transmitted in parallel. Because the cells are of the same size, no bandwidth is wasted in the crossbar. The cells switched through the fabric have a fixed size. This fixed size is typically chosen to correspond to the size of the smallest packet switched by the fabric, plus the size of any internal headers added by the router or switch before passing the packet through the fabric.

The fabric scheduler computes a new schedule for each batch of cells during the transmission time of a cell. In a high-speed switch, this time interval can be extremely short. For example, with a cell size of 64 bytes and a port rate of 10 Gigabits/second, the fabric scheduler schedules a new batch of cells every 51.2 nanoseconds. The crossbar switching matrix is also configured at intervals of 51.2 nanoseconds. As the port speed is increased, both the fabric scheduler and the crossbar reconfiguration are correspondingly made faster. This is especially a problem when an optical switching device is used as the crossbar switching matrix. While supporting very high data rates, many of the optical switching devices have long reconfiguration times. This makes them unsuitable for use in a cell-based fabric.

Another difficulty with the cell-based fabric is that it is difficult to separate the crossbar switching matrix (the data path) and the fabric scheduler, because the delays in communication between them can become a bottleneck. During every scheduling cycle, the header information (in particular, the destination port number) from cells stored in the input buffers of the crossbar matrix is passed to the fabric scheduler, and the crossbar configuration setting is communicated back from the scheduler to the crossbar matrix. If the scheduler is physically separated from the crossbar matrix (on separate chips or circuit boards), the delays in communication between the two may make it difficult to achieve the scheduling rate needed in a high-speed router or switch.

### BRIEF DESCRIPTION OF THE DRAWINGS

The features and advantages of the various embodiments will become apparent from the following detailed description in which:

FIG. 1 illustrates an exemplary block diagram of a store-and-forward device, according to one embodiment;

FIG. 2 illustrates an exemplary block diagram of a crossbar-based packet switching fabric, according to one embodiment;

FIG. 3 illustrates an exemplary cell-based switching fabric, according to one embodiment;

FIG. 4 illustrates an exemplary crossbar switching fabric, according to one embodiment;

FIG. 5 illustrates an exemplary distribution of packets being stored as segments in a single queue, according to one embodiment;

FIG. 6 illustrates an exemplary format of a frame made up of multiple segments, according to one embodiment;

FIG. 7 illustrates an exemplary store-and-forward device, according to one embodiment;

FIG. 8 illustrates an exemplary crossbar switching plane, according to one embodiment;

FIG. 9 illustrates an exemplary block diagram of an ingress fabric interface module, according to one embodiment;

FIG. 10 illustrates an exemplary block diagram of an egress fabric interface module, according to one embodiment;

FIG. 11 illustrates an exemplary block diagram of a fabric scheduler, according to one embodiment;

FIG. 12 illustrates an exemplary pipeline schedule for a switch fabric scheduler, according to one embodiment; and

FIG. 13 illustrates an exemplary crossbar switching plane that performs re-clocking, according to one embodiment.

### DETAILED DESCRIPTION

Store-and-forward devices, such as switches and routers, are used in packet networks, such as the Internet, for directing traffic at interconnection points. Store-and-forward devices include a plurality of interface modules, a switch fabric for selectively connecting different interface modules, and a backplane for connecting the interface modules and the switching fabric. The interface modules include receivers (ingress ports) to receive data from and transmitters (egress ports) to transmit data to multiple sources (e.g., computers, other store and forward devices) over multiple communication links (e.g., twisted wire pair, fiber optic, wireless). Each of the sources may be capable of transmitting/receiving data at different speeds, different quality of service, etc. over the different communication links. The interface modules can transmit/receive data using any number of protocols including Asynchronous Transfer Mode (ATM), Internet Protocol (IP), and (Time Division Multiplexing) TDM. The data may be variable length or fixed length packets, such as cells, or frames.

The data received from external sources is stored in a plurality of queues. The queues may be stored in any type of storage device and preferably are a hardware storage device such as semiconductor memory, on-chip memory, off-chip memory, field-programmable gate arrays (FPGAs), random access memory (RAM), or a set of registers. The interface modules may be line cards or chips contained on line cards. A single line card may include a single interface module (receiver or transmitter) or multiple interface modules (receivers, transmitters, or a combination). The interface modules may be Ethernet (e.g., Gigabit, 10 Base T), ATM, Fibre channel, Synchronous Optical Network (SONET), Synchronous Digital Hierarchy (SDH) or various other types. A line card having multiple interface modules may have the same type of interface modules (e.g., ATM) or may contain some combination of different interface module types. The backplane may be electrical or optical.

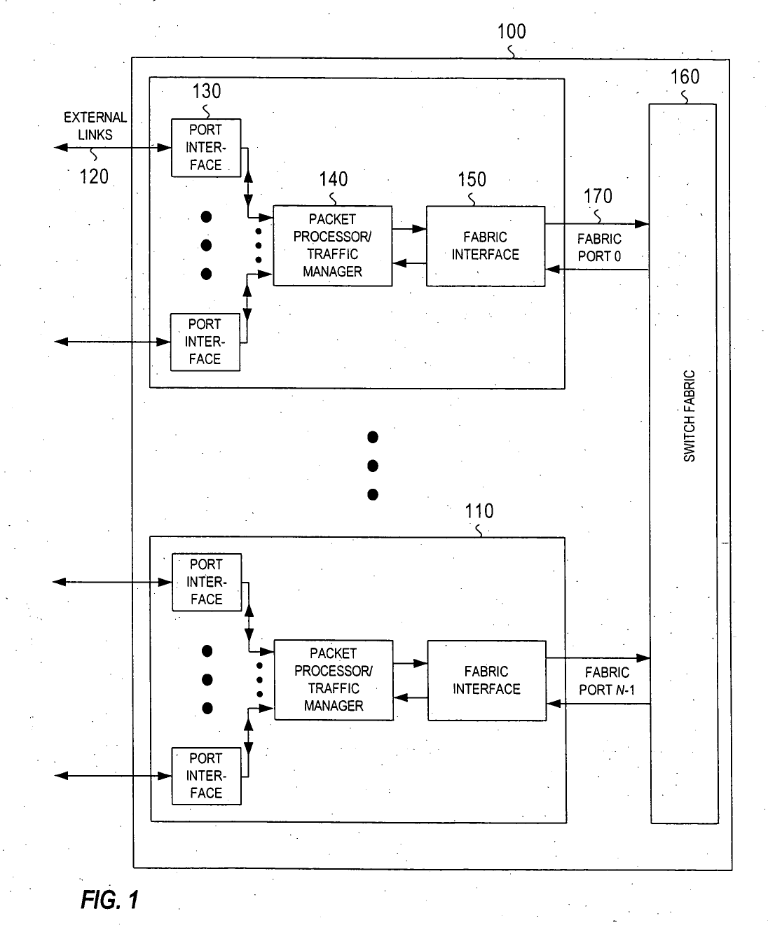

FIG. 1 illustrates an exemplary block diagram of a store-and-forward device 100. The device 100 includes a plurality of line cards 110 that connect to, and receive data from and transfer data to, external links 120. The line cards include port interfaces 130, packet processor and traffic manager devices 140, and fabric interfaces 150. The port interfaces 130 provide the interface between the external links 120 and the line card 110. The port interface 130 may include a framer, a media access controller, or other components to interface with the external links (not illustrated). The packet processor and traffic manager device 140 receives data from the port interface 130 and provides forwarding, classification, and queuing based on flow (e.g., class of service) associated with the data. The fabric interface 150 provides the interface necessary to connect the line cards 110 to a switch fabric 160. The fabric interface 150 includes an ingress port interface (from the line card 110 to the switch fabric 160) and an egress port interface (from the switch fabric 160 to the line card 110). For simplicity only a single fabric interface 150 is illustrated, however multiple fabric interfaces 150 could be contained on each line card 110.

The switch fabric 160 provides re-configurable data paths between the line cards 110 (or fabric interfaces). The switch fabric 160 includes a plurality of fabric ports 170 (addressable interfaces) for connecting to the line cards 110 (port interfaces). Each fabric port 170 is associated with a fabric interface (pair of ingress interfaces and egress interfaces). The switch fabric 160 can range from a simple bus-based fabric to a fabric based on crossbar (or crosspoint) switching devices. The choice of fabric depends on the design parameters and requirements of the store-and-forward device (e.g., port rate, maximum number of ports, performance requirements, reliability/availability requirements, packaging constraints). Crossbar-based fabrics are the preferred choice for high-performance routers and switches because of their ability to provide high switching throughputs.

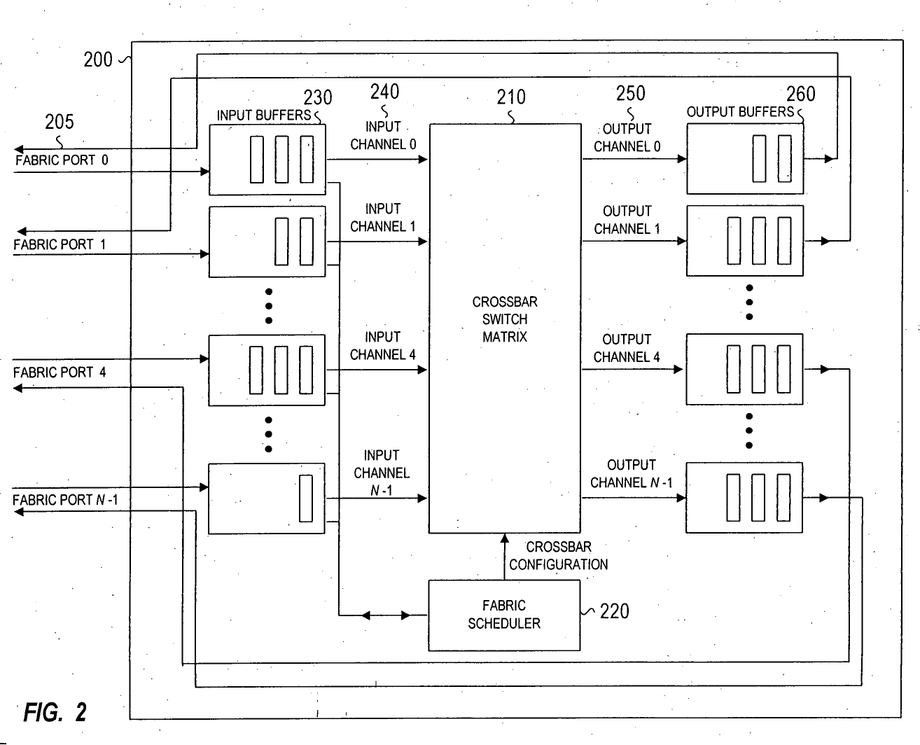

FIG. 2 illustrates an exemplary block diagram of a crossbar-based packet switch fabric 200. The fabric 200 includes a plurality of fabric ports 205 to connect to associated fabric interfaces (ingress/egress pair), a crossbar switching matrix 210, a fabric scheduler 220, input buffers 230 to hold arriving packets from the fabric ports 205, input channels 240 to transmit data from the input buffers 230 to the crossbar matrix 210 (e.g., associated ports), output channels 250 to transmit data from the crossbar matrix 210 (e.g., associated ports), and output buffers 260 to hold packets prior to departing from the fabric ports 205.

A backplane consists of a plurality of channels (input 240 and output 250) that provide connectivity between the fabric ports 205 and the crossbar matrix 210 so as to provide switching connectivity between line cards. With advances in serial communication technologies, the channels 240, 250 are preferably high-speed serial links. High-speed serial data can be carried over either electrical backplanes or optical backplanes. If an optical backplane is used, the transmitting line card converts electrical signals to optical signals and send the optical signals over fiber, and the destination line card receives the optical signals from the fiber and reconverts them to electrical signals.

The crossbar matrix 210 is logically organized as an array of N×N switching points, thus enabling any of the packets arriving at any of N input ports to be switched to any of N output ports, where N represents the number of fabric ports. These switching points are configured by the fabric scheduler 220 at packet boundaries. Typically, the packets are switched through the crossbar switching matrix 210 in batches, where a batch consists of at most one packet selected from each input port, in such a way that no more than one of the packets is destined for each out port.

Each of the packets, arriving at one of the input buffers 230, has a header containing the destination port number where it needs to be switched. The fabric scheduler 220 periodically reads the destination port information from the headers of the packets stored in the input buffers 230 and schedules a new batch of packets to be transferred through the crossbar switching matrix 210. The packets in a batch (a maximum of N packets) are transferred in parallel across the crossbar switching matrix 210. While the packets from a scheduled batch are being transferred through the crossbar 210, the scheduler 220 can select the packets to form the next batch, so that the transmission of the new batch of packets can start as soon as transmission of the current batch ends. At the end of each batch of packets, the fabric scheduler 220 re-configures the crossbar switching matrix 210 so as to connect each input port to the output port where its next packet is destined to.

Because the packets in the exemplary switching fabric 200 are transferred in batches, the switching paths in the crossbar switching matrix 210 are kept unchanged for the duration of the longest packet being transferred across the crossbar 210 in that batch. When the packets are of variable size (as is the case for packets generated by most network protocols in the industry), this results in wasted bandwidth. For example, when a 50-byte packet and a 1500-byte packet are part of the same batch, the crossbar 210 is maintained in the same configuration for the duration of the 1500-byte packet, and only 1/30^{th} of the bandwidth of the path is used by the 50-byte packet.

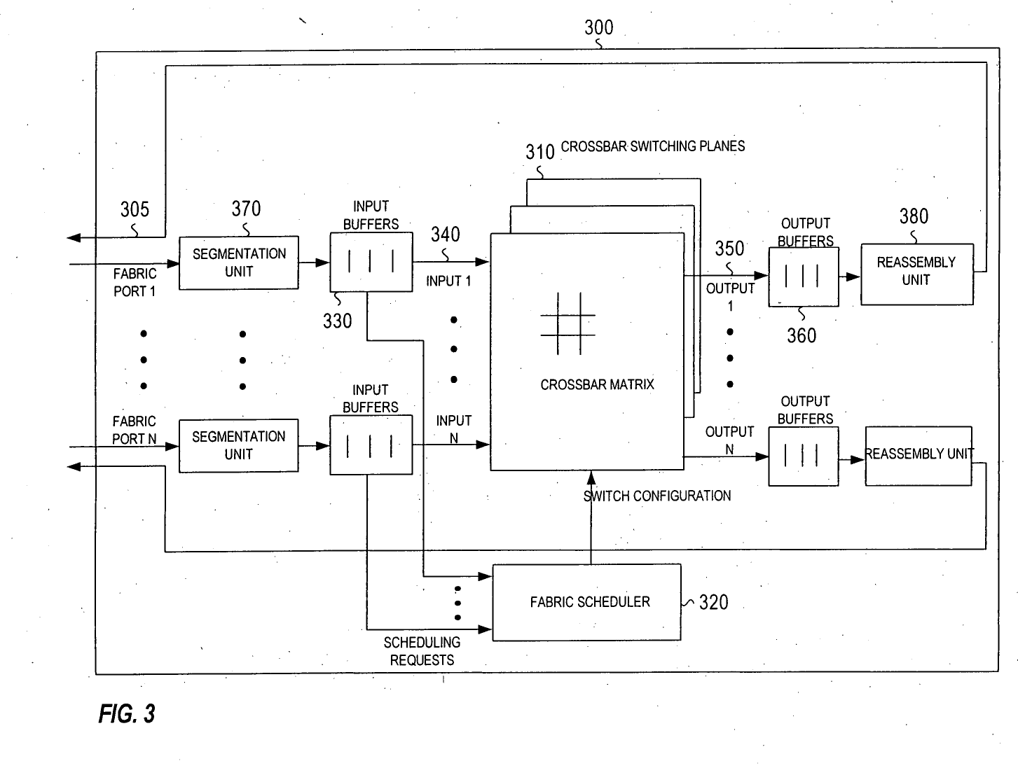

FIG. 3 illustrates an exemplary cell-based switching fabric 300. Like the switch fabric 200, the switch fabric 300 includes fabric ports 305, a crossbar switching matrix 310, a fabric scheduler 320, input buffers 330, channels 340, 350 and output buffers 360. In addition, the switch fabric 300 includes segmentation units 370 and reassembly units 380. The segmentation unit 370 divides the packets received at the fabric port 305 into cells (segments) having a fixed size. In addition the segmentation unit 370 adds a header to each of the cells so that the cells can be identified with one another and put back together. The reassembly unit 380 receives the cells and re-generates the packet based on the cells. The reassembly unit 380 uses the headers to identify which cells are part of the packet.

The fixed size of the cells may be chosen to correspond to the size of the smallest packet switched by the switch fabric 300, plus the size of any internal headers added. For example, if the smallest packet is of size 64 bytes, and the size of the internal headers is 16 bytes, a cell size of 64+16=80 bytes can be chosen. A packet larger than 64 bytes, arriving in the switch fabric 300, will be segmented into multiple cells of maximum size 64 bytes by the segmentation unit 370 before switching through the crossbar matrix 310. For example, if a 180 byte packet is received it will be broken into 2 cells each the maximum 64 bytes and one cell having 52 bytes. The last cell is padded to 64 bytes so that the cells are the same size. Each of these cells is appended with a header (e.g., 16 bytes). After the cells (data and header) are switched through the crossbar matrix 310 they are combined into the original packet by the reassembly unit 380.

The fabric scheduler 320 works in the same way as the fabric scheduler 220 from FIG. 2. Each of the cells arriving at the input buffers has a header containing the port number where it is destined to. The fabric scheduler 320 may select one cell from each input port to form a batch, such that the destination port numbers associated with the cells in the same batch are distinct. The cells within the same batch are then transmitted in parallel. Because the cells are of the same size, no bandwidth is wasted in the crossbar matrix 310. The fabric scheduler 320 determines (schedules) the next batch for transmission during transmission of the current batch. In a high-speed switch, this time interval can be extremely short. For example, with a total cell size of 80 bytes (64 byte packet and 16 byte header), and a port rate of 10 Gigabits/second (10 Gbs), the fabric scheduler 320 schedules a new batch of cells every 64 nanoseconds ((80 bytes×8 bits/byte)/10 Gbs). The crossbar switching matrix 310 is also configured at intervals of 64 nanoseconds. As the port speed is increased, both the fabric scheduler 320 and the crossbar 310 reconfiguration is correspondingly made faster. Another difficulty with the cell-based fabric 300 is that it is difficult to separate the crossbar switching matrix 310 (the data path) and the fabric scheduler 320, because the delays in communication between them can become a bottleneck.

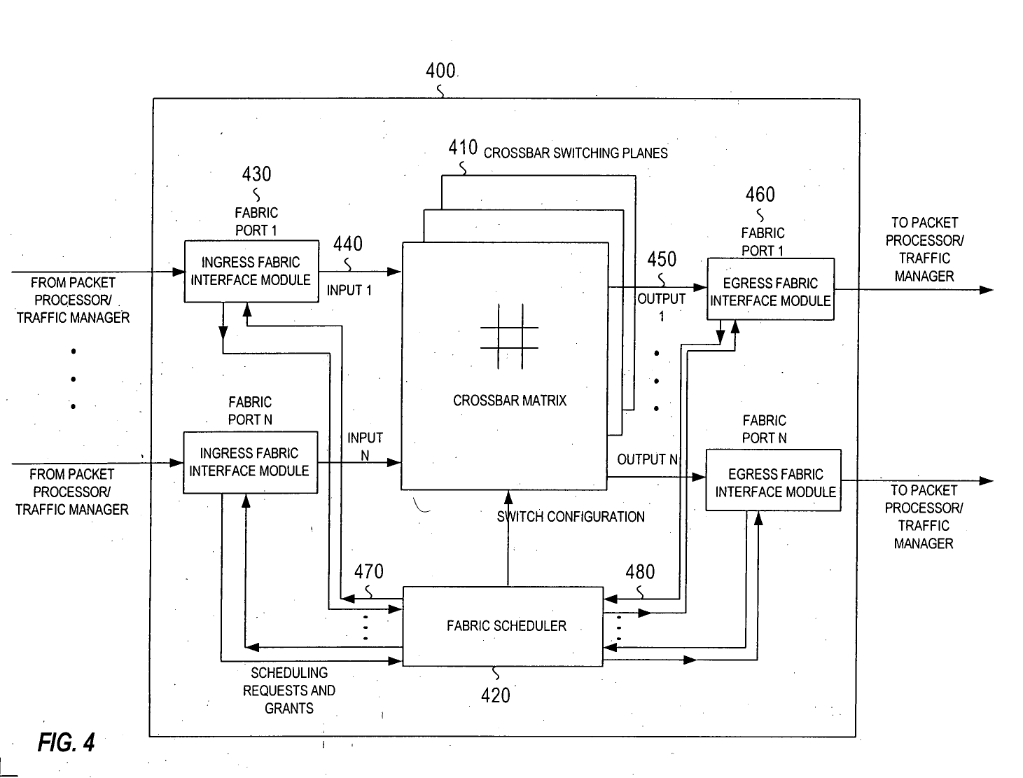

FIG. 4 illustrates an exemplary block diagram of switching fabric 400. The switching fabric 400 introduces a data aggregation scheme wherein the variable-size packets arriving into the store-and-forward device (e.g., router, switch) are first segmented into smaller units (segments) and then aggregated into convenient blocks (“frames”) for switching. The switching fabric 400 includes a switching matrix 410 (made up of one or more crossbar switching planes), a fabric scheduler 420, ingress fabric interface modules 430, input data channels 440 (one or more per fabric port), output data channels 450 (one or more per fabric port), egress fabric interface modules 460, ingress scheduling channels 470 and egress scheduling channels 480. According to one embodiment, the data channels 440, 450 are separate from the scheduling channels 470, 480. In an alternate embodiment, the scheduling information can me multiplexed with data and sent over the same physical links, and the scheduler 420 can be integrated with one or more crossbar planes 410 as well. However, the scheduling function remains logically separate from the data path.

The ingress fabric interface module 430 receives packets from the packet processor/traffic manager device on a line card. The packet processor/traffic manager is responsible for processing the packets arriving from the external links, determining the fabric port number associated with the incoming packet (from a header lookup), and attaching this information to the packet for use by the switching fabric 400. The ingress fabric interface module 430 receives the packets, stores the packets in associated queues, and sends the packets to the switching matrix 410 for transfer to a different line card. The egress fabric interface modules 460 are responsible for receiving packets arriving from the switching matrix 410 (typically from a different line card), and passing them on for any egress processing needed in a line card and subsequently for transmission out on the external links. It should be noted that a fabric port may aggregate traffic from more than one external port (link) associated with a line card. A pair of ingress and egress fabric interface modules 430, 460 is associated with each fabric port. When used herein the term fabric port may refer to an ingress fabric interface module and/or an egress fabric interface module. An ingress fabric interface module may be referred to as a source fabric port, a source port, an ingress fabric port, aan ingress port, a fabric port, or an input port. Likewise an egress fabric interface module may be referred to as a destination fabric port, a destination port, an egress fabric port, an egress port, a fabric port, or an output port.

The ingress fabric interface modules 430 store the packets arriving from the packet processor/traffic manager in a set of queues. The packets destined to the egress fabric interface modules 460 are maintained in a separate queue (isolated from each other). In addition, the packets destined to a specific egress fabric interface module 460 can further be distributed into multiple queues based on their class of service or relative priority level. These queues may be referred to as virtual output queues. The packets may be broken down into segments and the segments stored in the queues. The segments can be variable size but are limited to a maximum size.

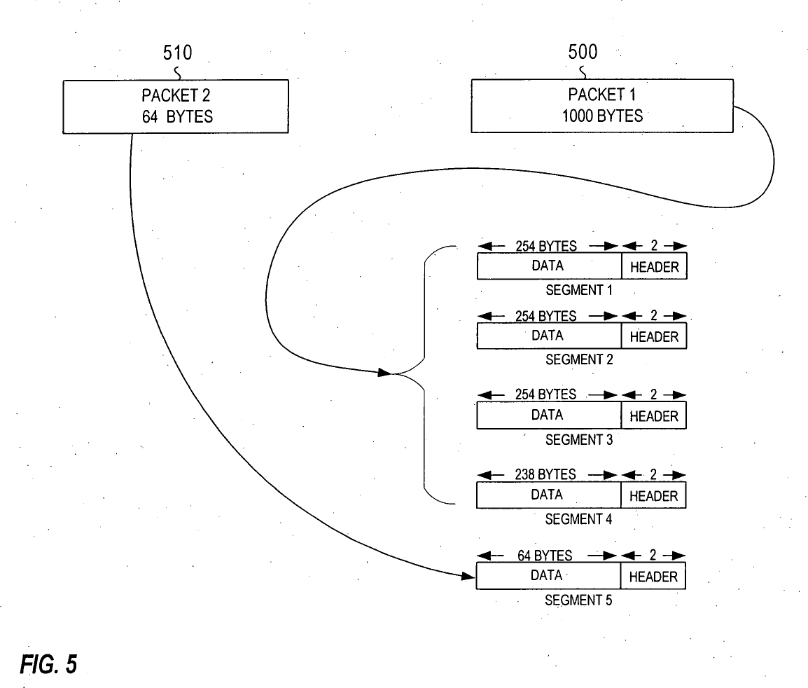

FIG. 5 illustrates an exemplary distribution of packets being stored as segments in a single queue (corresponding to specific destination port and priority level) within an ingress fabric interface module. Two packets are received from the packet processor/traffic manager device on the line card. The first packet 500 is 1000 bytes and the second packet 510 is 64 bytes. The maximum size of a segment is 256 bytes (254 data bytes and a 2 byte segment header). The first packet (1000 bytes) 500 is broken into three 254 byte maximum data size segments (3×254=762 bytes) and a fourth segment of 238 bytes of data. Each of the four segments has a two byte segment header added and the overall segments (data and header) are stored in the queue. Accordingly, the four overall segments include three 256 byte segments and a 240 byte segment. The second packet (64 bytes) 510 is less than the maximum segment size so it has the two byte header appended to it and is saved in the queue as a 66 byte segment.

The segment header identifies the queue in which the segment is to be placed upon its arrival in the egress fabric interface module. The number of queues is dependent on number of priority levels (or class of services) associated with the packet. Furthermore, the number of queues may also be dependent on number of ingress fabric interface modules that can send data to the egress fabric interface module. For example, if the egress fabric interface module receives data from 8 line card ports (ingress fabric interface modules) and each line card port supports 4 levels of priority for packets to that egress fabric interface module, then the segments arriving at the egress fabric interface module may be placed in one of 32 queues (8 ingress fabric interface modules×4 priorities per ingress module). Therefore, a minimum of 5 bits are needed in the segment header to identify one of the 32 queues. The segment header also includes an “End of Packet” (EOP) bit to indicate the position of the segment within the packet where it came from. The EOP bit is set to 1 for the last segment of a packet, and 0 for the other segments. This enables the egress modules to detect the end of a packet.

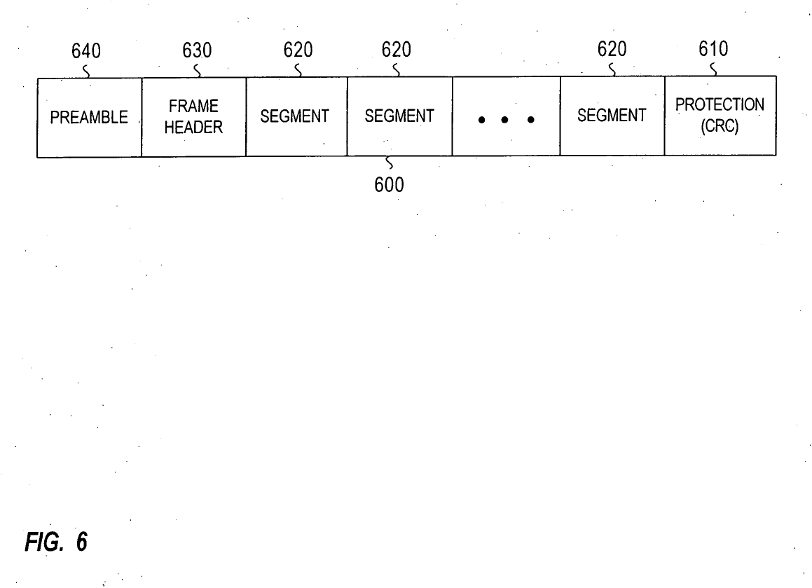

The segments stored in its queues are aggregated into frames by the ingress fabric interface module 430 before transmission to the crossbar matrix 410. FIG. 6 illustrates an exemplary format of a frame 600 (made up of multiple segments) being transmitted by an ingress fabric interface module to an egress fabric interface module via the crossbar matrix 410. The frame 600 starts with a preamble 640, frame header 630, followed by one or more segments 620, and a protection/error detection field 610 (e.g., a Cyclic Redundancy Code (CRC)). The frame header 630 contains fields identifying the ingress and egress fabric interface modules associated with the frame, and other optional information. This information is used by the egress fabric interface module for data identification and for error checking. The maximum size of the frame is a design parameter. The preamble 640 is for establishing synchronization at the egress fabric interface module 460. The time taken to transmit the maximum-size frame is referred to as the “frame period.” This interval is the same as a scheduling interval (discussed in further detail later).

The frame period can be chosen independent of the maximum packet size in the system. Typically, the frame period is chosen such that a frame can carry several maximum-size segments. The frame period is often determined by the reconfiguration time of the crossbar data path. For example, the switching time of certain optical devices are currently of the order of microseconds. If such devices are used for the data path, the frame period is on the order of microseconds. Electronic switching technologies, on the other hand, are significantly faster, allowing frame periods in the range of tens to hundreds of nanoseconds.

Another factor that needs to be taken into account while choosing the frame period is the overhead in synchronizing the egress fabric interface modules with the data streams at the start of a frame. Data streams are broken at the end of a frame and the new arriving frame may be from a different ingress fabric interface module (resulting in a change in frequency and/or phase of the clock associated with the data stream). Accordingly, the egress fabric interface modules re-establish synchronization at the boundary of every frame. This requires a preamble at the beginning of each frame that does not carry any data, but only serves to establish synchronization.

The ingress fabric interface module constructs a frame by de-queuing one or more segments from its queues when instructed to do so by a grant from the fabric scheduler (discussed in further detail later). A grant may be received by an ingress fabric interface module during each frame period. The grant identifies the subset of queues from which data need to be de-queued based on the destination fabric port (egress fabric port module). This de-queuing of segments proceeds until the frame is full. Because the segments cannot be broken up further, and a frame consists of a whole number of segments, each frame constructed may not have the same size, but will always be within the maximum size specified. Alternatively, the frames that do not equal the maximum frame size can be padded to the maximum size so that the frames are the same size.

By way of example, assume that the maximum frame size is 1000 bytes and that ingress port 1 just received a grant to transmit data to egress port 2 (queue 2). Assume that queue 2 has the following segments stored therein: segment 1—256 bytes, segment 2—256 bytes, segment 3—200 bytes, segment 4—256 bytes, segment 5—64 bytes, and segment 6—128 bytes. The frame would be constructed to include as many full segments as possible. In this case the first 4 segments would be selected and utilize 968 bytes. As the fifth segment cannot fit within the frame without exceeding the maximum frame size, the segment is not included. The frame is transmitted as a 968 byte frame. Alternatively, the frame can be padded to the maximum 1000 byte frame size.

If there are multiple queues (based on priority, class of service) associated with a specific destination, the ingress module chooses one or more queues from this subset based on a scheduling discipline. The scheduling discipline may be based on priority (e.g., highest priority first). That is, the queues may be serviced in order of priorities, starting from the highest priority queue and proceeding to the next priority level when the current priority level queue is empty. This de-queuing of segments proceeds through queues (priorities) until the frame is full.

By way of example, assume the same maximum frame size of 1000 bytes and that ingress port 1 just received a grant to transmit data to egress port 2 (queues 4-6 corresponding to priorities 1-3). Assume that queue 4 includes segment 1—256 bytes and segment 2—256 bytes; queue 5 includes segment 3—200 bytes; and queue 6 includes segment 4—256 bytes, segment 5—64 bytes, and segment 6—128 bytes. The frame would include segments 1 and 2 from queue 4, segment 3 from queue 5, and segment 4 from queue 6. These 4 segments selected from three different queues (priorities) generate a 968 byte frame. The frame may be transmitted as a 968 byte frame or alternatively may be padded to the maximum 1000 byte frame size.

While constructing the frame, the segments from multiple packets may be interleaved within a frame. Because the segment header provides identifying information for re-assembling them into the original packets, such interleaving does not violate data integrity. The only constraint to be satisfied is that two segments from the same packet should not be sent out of order. By way of example, assume that packet 1 includes segments 1-5 and packet 2 includes segments 6-8 and that both packets (segments associated with) can fit within the maximum size frame. The order of the packets in the frame may be 1, 2, 3, 6, 4, 7, 8, and 5. That is the packets are interleaved within one another but the order of the segments associated with a packet are in order.

When there is only a single crossbar switching plane present, the frame is transmitted in bit-serial fashion through the crossbar planes. When multiple crossbar planes are used, the contents of the frame are striped over the available crossbar planes. Striping may be performed at the bit, byte, or word level. Additional channels may be used for protection (error detection and correction).

Referring back to FIG. 4, the fabric scheduler 420 is responsible for scheduling transmissions from the ingress fabric interface modules 430 to the egress fabric interface module 460 via the crossbar matrix 410. The operation of the scheduler 420 is synchronous with respect to a frame clock. During each cycle of the frame clock, each of the ingress fabric interface modules 430 transmits information (e.g., requests) on the packets waiting in its queues to the scheduler 420. This information is sent across the links 470 connecting the fabric scheduler 420 to the ingress fabric interface modules 430. Information transmitted from the ingress fabric interface modules 430 to the fabric scheduler 420 in each cycle of the frame clock can be regarded as a set of requests from the fabric ports for use of the crossbar datapath. The information provided by each ingress fabric interface modules 430 consists of, at a minimum, the destination fabric port numbers associated with its non-empty queues.

For example, assume that the ingress fabric interface module associated with fabric port 1 has five packets in its queue, two of which are destined to fabric port 3, and one each to fabric ports 5, 6 and 7, respectively. Then, the information transmitted from the ingress fabric interface module 1 in that cycle will carry at least one bit corresponding to each of the fabric ports 3, 5, 6 and 7 to identify the non-empty queues. The information can optionally include many other attributes, such as the amount of data in each queue and the “age” (time interval since a packet was last transmitted) of each queue. In addition, if there are multiple queues associated with each destination port, based on priority or class, then the information may include the amount of data queued at each priority level for each destination port.

A basic fabric scheduler implementation may need only the basic information (ID of non-empty queues) to be passed from the ingress fabric interface modules. More powerful scheduler implementations, supporting additional features, require more information to be passed from the ingress fabric interface modules and higher bandwidth links (or stripping of the requests over multiple links) connecting them to the scheduler.

Based on the information received from the ingress fabric interface modules 430, the fabric scheduler 420 computes a schedule for the crossbar planes 410. The schedule is computed by performing a matching of the requests received from the ingress fabric interface modules 430 and resolving any conflicts therebetween. For example, assume ingress fabric interface module 1 has packets queued for destinations 5 and 7, while ingress fabric interface module 2 has packets queued for destinations 5 and 9. During the matching phase, the scheduler 420 could match both of the ingress modules to destination 5. However, the scheduler 420 would realize the conflict and modify the schedule accordingly. The scheduler 420 may schedule ingress module 1 to send packets to destination 7 and ingress module 2 to send to destination 5, enabling both transmissions to occur in parallel during the same frame cycle. In practice, the fabric scheduler 420 may use criteria such as, the amount of data queued at various priorities, the need to maintain bandwidth guarantees, and the waiting times of packets, in the computation of the schedule.

The scheduler 420 then sets the crossbar matrix (planes) 410 to correspond to this setting. For example, if the fabric scheduler 420 generates a schedule in which the ingress fabric interface module 1 is to transmit a packet in its queue to destination port 4 in the current cycle, the scheduler 420 configures the crossbar matrix 410 to connect ingress port 1 to egress port 4 during the current frame cycle. If there are multiple crossbar planes used to stripe the data, then the planes are set in parallel to the same configuration.

After the fabric schedule 420 computes its schedule, the scheduler 420 communicates back to each ingress fabric interface module 430 the schedule information (grants) computed. The information sent to a particular ingress modules includes, at a minimum, the destination fabric port number to which it was matched. Upon receiving this information, the ingress fabric interface modules 430 de-queue data (segments) from the associated queue(s) and transmit the data (frames) to the crossbar data planes (previously discussed). This is done in parallel by the interface modules 430. Because the fabric scheduler 420 sets the crossbar planes 410 to correspond to the schedule information (grants) communicated to the ingress fabric interface modules 430, the data transmitted by the ingress modules 430 will reach the intended destination egress interface modules 460.

While communicating the schedule information (grants) to the ingress fabric interface modules 430, the fabric scheduler 420 may optionally send information about the computed schedule to the egress fabric interface modules 460. Specifically, the scheduler 420 may send to each egress module 460 the port number associated with the ingress module 430 that will be transmitting data to it in that cycle. Although this information can be provided within the data stream itself (as part of header), sending it directly from the fabric scheduler 420 enables the egress modules 460 to detect errors by comparing the source of the arriving data (obtained from the headers) with the scheduler-supplied port number. A mismatch indicates an error or failure in the switch fabric system. The arriving data can be discarded in such an event, thus avoiding delivery of data to an unintended port.

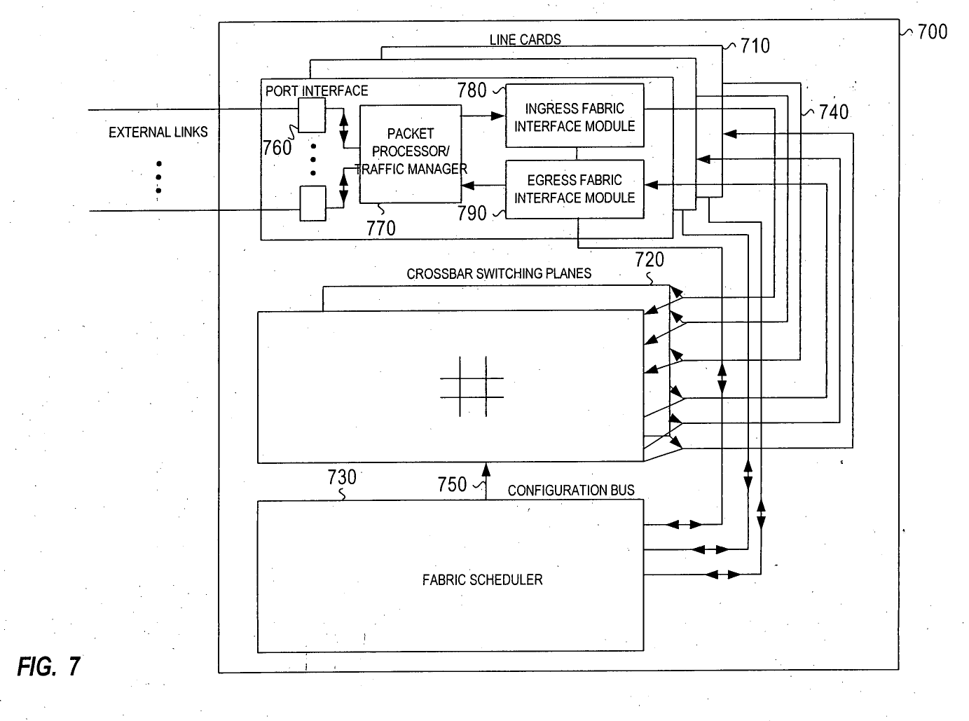

FIG. 7 illustrates an exemplary store-and-forward device 700. The store-and-forward device 700 includes line cards 710, crossbar switching planes 720, a fabric scheduler 730, a backplane 740 made up of a plurality of serial channels for connecting the line cards 710 to the crossbar switching planes 720 and the fabric scheduler 730, and a configuration bus 750 for providing communications between the fabric scheduler 730 and the crossbar switching planes 720. The line cards 710 include port interfaces 760, packet processor and traffic manager devices 770, ingress fabric interface modules 780 and egress fabric interface modules 790. As previously noted a pair of ingress 780 and egress fabric interface modules 790 are associated with a fabric port. There can be one or more fabric ports located on each line card.

The crossbar switching planes 720 and the fabric scheduler 730 reside on one or more switch cards. The backplane 740 (serial channels) form the data path over which packets are transported through the crossbar switching planes 720. When the bandwidth of a single serial channel (link) is inadequate to support the data rate of each fabric port, data is striped over multiple channels. Such striping can be at different granularities (e.g., bit, byte, word). If the data is stripped over several channels, there will be a corresponding number of crossbar planes. The crossbar planes may be separate crossbar matrixes or may be a single crossbar matrix containing multiple planes. Additionally, more links and switching planes may be used to provide speedup, redundancy, error detection and/or error recovery.

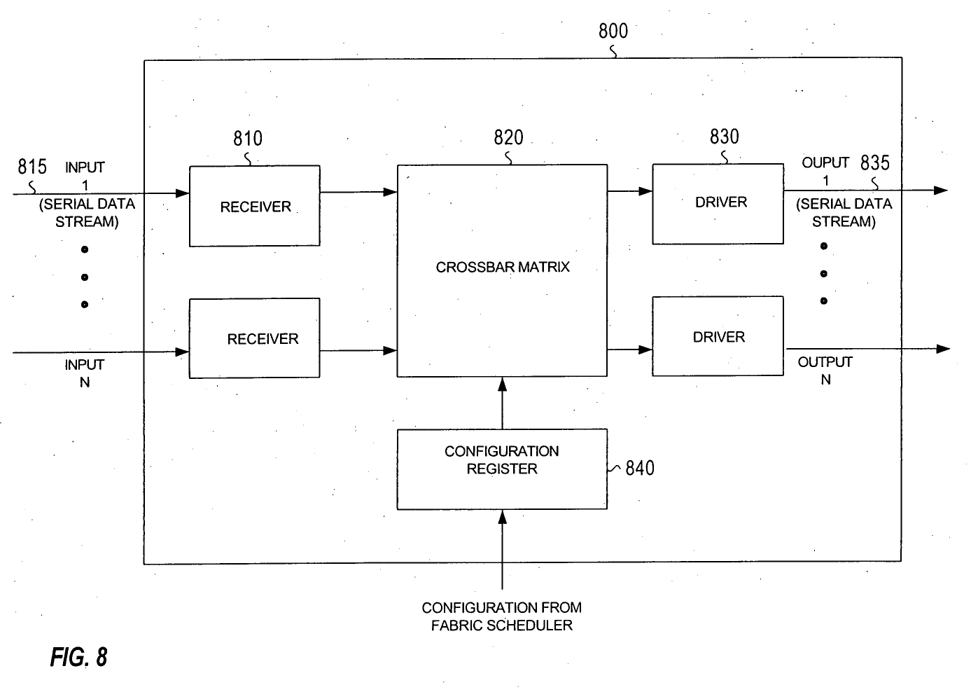

FIG. 8 illustrates an exemplary crossbar switching plane 800. The crossbar switching plane 800 includes receivers 810, a crossbar matrix 820, drivers 830 and a configuration register 840. The receivers 810 receive data from the fabric ports (ingress fabric interface module) via input serial channels (links) 815. The cross bar matrix 820 selectively connects input fabric ports (ingress ports) to output fabric ports (egress ports). The drivers 830 forward the output of the crossbar matrix 820 to the appropriate fabric ports via output serial channels (links) 835. The configuration register 840 receives scheduling directions from a fabric scheduler and directs the crossbar matrix 820 accordingly. The crossbar switching plane 800 has a “pass-through” data path. That is, incoming data is transmitted to a selected output of the crossbar switching plane 800 without any buffering (other than any buffering needed for clocking, etc., which is typically of the range of a few bits or bytes).

This enables the use of a fast crossbar switching plane 800 (e.g., optical switching device), as it needs to incorporate only the data path, and does not need to provide buffering and scheduling functions. Additionally, the serial channels 815, 835 between the fabric ports and the crossbar switching plane 800 may be optical (such as optical fiber links). Thus, according to one embodiment the path from the ingress fabric interface module to the egress fabric interface module is completely optical. Optoelectronic modules within the ingress and egress fabric modules perform conversion of the electrical data into optical and back.

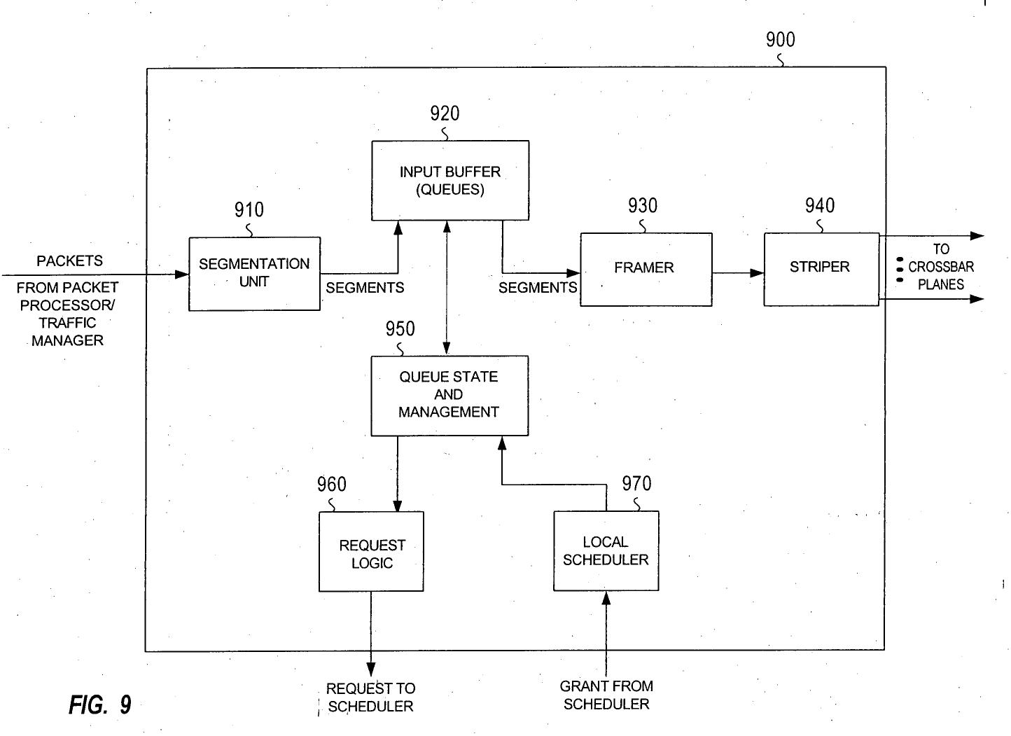

FIG. 9 illustrates an exemplary block diagram of an ingress fabric interface module 900. The ingress fabric interface module 900 includes a segmentation unit 910, an input buffer (holding the virtual output queues) 920, a framer 930, a striper 940, a queue state manager 950, a request logic 960, and a local scheduler 970. Packets (variable-length) arriving from a packet processor/traffic manager are segmented into segments of the specified maximum size by the segmentation unit 910. The segments are then stored in the input buffer 920 in appropriate queues based on the destination fabric port number (egress fabric interface module) and priority level. The queue state manager 950 maintains the status of each queue (updated when a segment is queued or de-queued). Based on the status of the queues the request block 960 generates requests and sends them to a scheduler.

The scheduler generates a schedule and transmits grants to the associated ingress fabric interface modules. The grant identifies, by fabric port number, the subset of queues to de-queue from. The grant is received from the scheduler by the local scheduler 970. The local scheduler 970 determines the associated queues. The framer 930 de-queues segments from these queues using an appropriate service discipline and constructs a frame therefrom. The data (frame) is then sent to the crossbar. If the data needs to be striped across multiple channels the striper 940 does so.

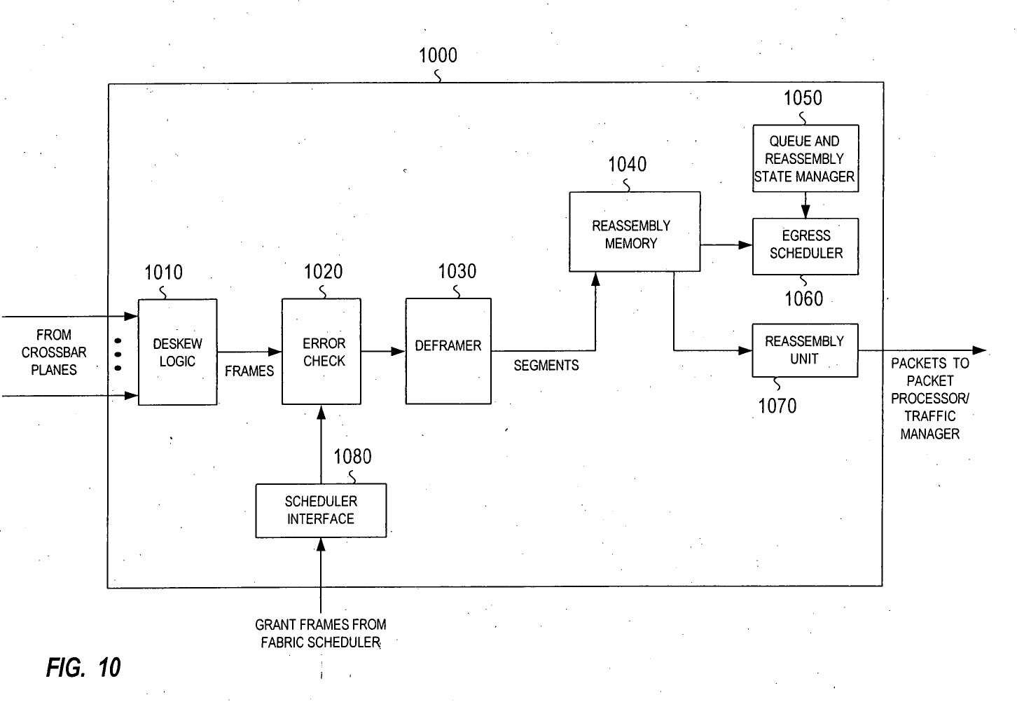

FIG. 10 illustrates an exemplary block diagram of an egress fabric interface module 1000. The egress fabric interface module 1000 includes a deskew logic 1010, an error checker 1020, a deframer 1030, a reassembly memory 1040, a queue and reassembly state manager 1050, an egress scheduler 1060, a reassembly unit 1070, and a scheduler interface 1080. The frame from the crossbar planes is received. If the frame was striped, the deskew logic 1010 deskews the stripes and combines them into the original frame. The error checker 1020 then checks the frame for errors using the CRC in the frame. The schedule interface 1080 receives grants from the scheduler.

According to one embodiment, the scheduler sends the grants to all egress modules (multicast the schedule) regardless of whether the grant pertains to that egress module. The schedule interface 1080 determines if the grant is applicable based on the destination port number specified in the header of the frame (matched against the address of the egress module). Alternatively, the grants are sent to only the applicable egress modules. The schedule interface 1080 also extracts the source fabric port number within the header of the frame and provides the source fabric number to the error checker 1020. The error checker checks the source fabric number contained in the grant (received from the scheduler) with the source fabric port number from the frame to check for errors. A mismatch indicates an error. In the case of an error, the frame is discarded and the appropriate error handling procedure is invoked.

The deframer 1030 receives the error-free frames and extracts the segments from within them. These segments are queued in the reassembly buffer 1040. The queue number associated with each segment is inferred from information in its header such as the priority level and address of the line card port where it is to be delivered. The queue and reassembly state manager 1050 maintains the status of each packet (e.g., complete, partial). The status is updated when a segment is queued or de-queued. In addition, the queue and reassembly state manager 1050 monitors the EOP bit in each segment in order to determine when complete packets are available. The local egress scheduler 1060 is responsible for making decisions to de-queue packets from the reassembly buffer 1040. A queue is eligible for de-queuing if it has at least one full packet. The scheduler 1060 selects the queue for de-queuing based on a service discipline such as round robin or strict priority. The de-queued segments are then reassembled into the original packet by the reassembly unit 1070 and forwarded to the line card.

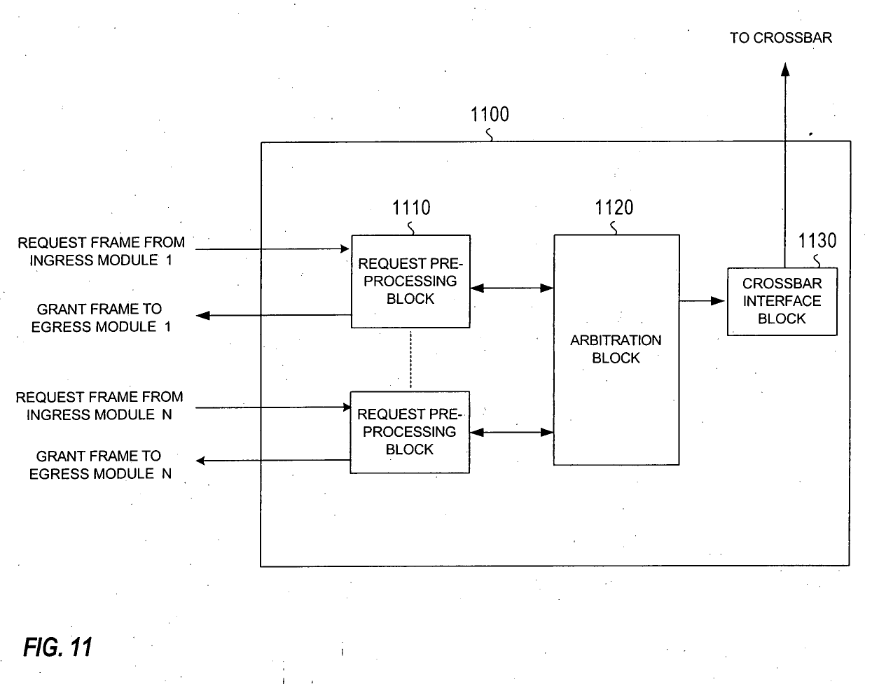

FIG. 11 illustrates an exemplary block diagram of a fabric scheduler 1100. The fabric scheduler 1100 includes a plurality of request pre-processing blocks 1110, an arbitration block 1120, and a crossbar interface block 1130. A request frame is received from the ingress fabric interface modules, and the request pre-processing block 1110 processes the requests and forwards the requests (including priority levels) to the arbitration block 1120. The arbitration block 1120 determines matches between the input ports and output ports and generates a schedule based thereon (list of grants indicating which ingress modules will send data to which egress modules). The schedule (grants) is provided to the request pre-processing blocks 1110 and the crossbar interface block 1130. The request pre-processing blocks 1110 send the grant message to the egress fabric interface modules. The crossbar interface block configures the crossbar based on the grants (ingress module to egress module matches).

Configuring a switch fabric includes communicating scheduler requests from the ingress modules to the fabric scheduler, the scheduler's computation of a schedule (crossbar setting), communicating the results in the form of grants to the ingress and egress interface modules, and configuring the crossbar planes to correspond to the computed schedule. In a large switch fabric with several fabric ports, the ingress and egress fabric interface modules may be distributed over several line cards and the crossbar data paths may consist of several switching planes located over multiple cards. Configuring a large switch fabric (large number of inputs and outputs) may take several clock cycles. Thus, the overheads associated with communicating requests, schedule computation, communicating grants, and crossbar configuration can be significant. No data can be transmitted until these operations are completed so a large amount of the switch bandwidth can be potentially lost.

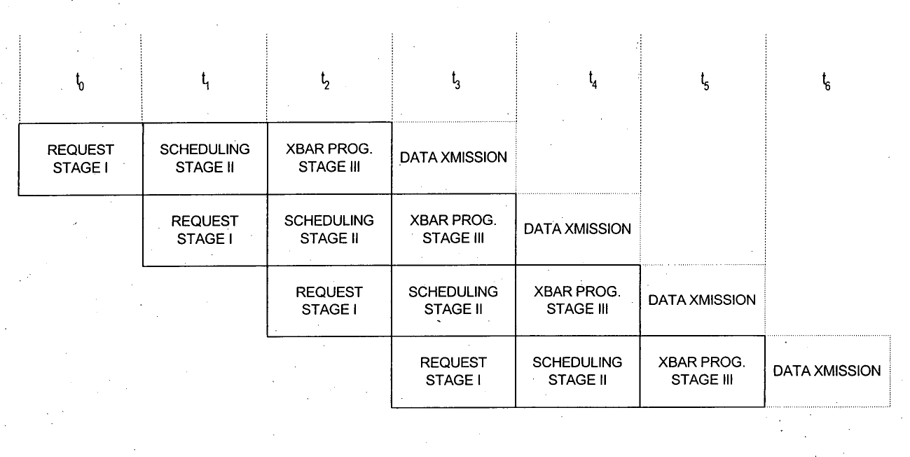

FIG. 12 illustrates an exemplary pipeline schedule for a switch fabric. The pipeline schedule includes 4 stages. Stage I is the request stage. During this stage, the ingress fabric interface modules send their requests to the fabric scheduler. The scheduler can perform some pre-processing of the requests in this stage while the requests are being received. Stage II is the schedule stage. During this stage, the scheduler matches each input (ingress module) to an output (egress module). At the end of this stage, the scheduler sends a grant message to each ingress fabric interface module specifying the egress module to which it should be sending data. The scheduler may also send the grants to the egress modules for error detection. Stage III is the crossbar configuration stage. During this stage, the scheduler configures the crossbar planes based on the matches computed during stage II. While the crossbar is being configured, each of the ingress modules de-queues data from its queues corresponding to the matched egress module, and forms a frame. Stage IV is the data transmission stage. During this stage, the ingress modules transmit their data frames across the crossbar.

Each stage occurs during a frame period (the basic time unit for system operation). Therefore, each pipeline stage is one frame period. As illustrated, during a first frame period, t₀, a request is sent from the ingress modules to the scheduler. During a second frame period, t₁, the scheduler generates a schedule based on the request from the first frame period. In addition, new requests are sent to the scheduler from the ingress modules. That is, two tasks are being performed during the second frame period. During a third frame period, t₂, the crossbar is being configured in response to the schedule generated in the second frame period, the scheduler is generating a schedule for the requests from the second frame period and additional requests are being sent. That is, three tasks are being performed during this frame period. During a fourth frame period, t₃, the data is being transmitted across the crossbar configuration from the third frame period, the crossbar is being configured in response to the schedule generated in the third frame period, the scheduler is generating a schedule for the requests from the third frame period and additional requests are being sent. That is, four tasks are being performed during the same frame period.

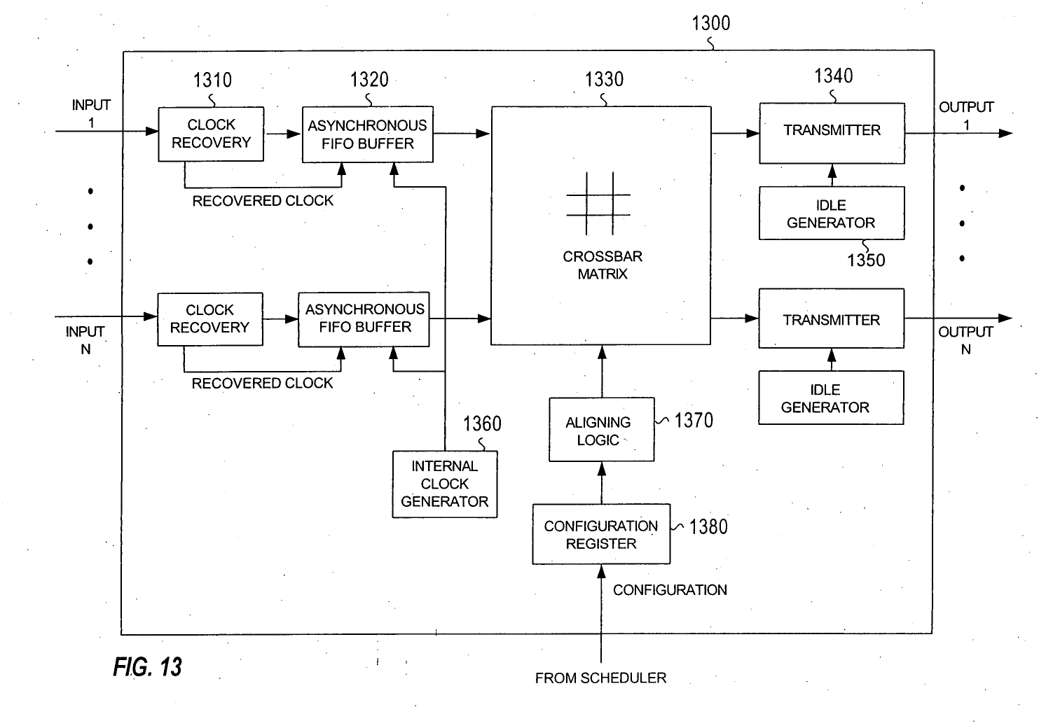

As noted with respect to FIG. 6, a preamble in the frame establishes synchronization. FIG. 13 illustrates an exemplary switch fabric 1300 that performs re-clocking and therefore eliminates the synchronization overhead at frame boundaries and does not require the frame to have a preamble. The switch fabric 1300 includes clock recovery units 1310, asynchronous FIFO buffers 1320, a crossbar matrix 1330, transmitters 1340, idle generators 1350, an internal clock generator 1360, aligning logic 1370, and a configuration register 1380. The clock recovery units 1310 recover a clock from the incoming data streams received from the ingress fabric interface modules. The clock recovery units 1310 provide the data and the recovered clock to the asynchronous FIFOs 1320. The asynchronous FIFOs 1320 convert the reference clock for the data stream to the common internal clock generated by the internal clock generator 1360. The clock domain is converted to the reference clock by inserting or removing idle characters between frames to accommodate for any differences in frequency and phase between the recovered clock and the reference clock. The frames are passed through unmodified to the corresponding outputs. The asynchronous FIFOs 1320 also compensate for any skew among the various inputs of the crossbar. Thus, data transmitted out of the crossbar are referenced on the same common clock. The configuration register 1380 stores the configuration provided by the scheduler. The aligning logic 1370 aligns any configuration changes made by the crossbar to take effect at the next frame boundary, so that the data stream transmitted at each output makes a transition from one source to another only at the end of a frame. The idle character generator 1350 maintains a constant supply of idles when there is no frame being transmitted by the transmitters 1340. These features enable the receivers at the egress fabric interface modules to remain in sync with the data streams, thus eliminating the need to acquire synchronization at each frame boundary.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” appearing in various places throughout the specification are not necessarily all referring to the same embodiment.

Different implementations may feature different combinations of hardware, firmware, and/or software. For example, some implementations feature computer program products disposed on computer readable mediums. The programs include instructions for causing processors to perform techniques described above.

The various embodiments are intended to be protected broadly within the spirit and scope of the appended claims.

1. A switching device comprising
a segmentation unit to receive data packets of variable size and to store the data packets as segments, wherein the data packets received having a length greater than a maximum segment length are divided into multiple segments;
a plurality of queues to store the segments, wherein the queues are associated with destinations;
a scheduler to generate a schedule including a data path from at least one queue to an associated destination;
a framer to aggregate a plurality of segments to form a frame, wherein the frame has a maximum frame length, wherein the segments are retrieved from the at least one queue, and wherein the frame may contain segments associated with different data packets; and
a transmitter to transmit the frame to the associated destination, wherein the segments within the frame are transmitted together.

2. The device of claim 1, wherein said segmentation unit divides the data packets having a length greater than the maximum segment length to form at least a first segment having the maximum segment length.

3. The device of claim 2, wherein a last segment formed by said segmentation unit may be less than the maximum segment length.

4. The device of claim 1, wherein said segmentation unit identifies a final segment belonging to a particular data packet.

5. The device of claim 1, wherein said scheduler generates the schedule based on requests for data packets from particular queues to be transmitted to particular destinations.

6. The device of claim 5, wherein said scheduler matches the requests and resolves conflicts in order to generate the schedule.

7. The device of claim 1, wherein said plurality of queues include one or more queues per destination based on priorities associated with the destinations.

8. The device of claim 1, wherein said framer forms the frame by aggregating segments from some subset of the one or more associated queues.

9. The device of claim 1, wherein said framer forms the frame by aggregating complete segments.

10. The device of claim 9, wherein said framer pads the frame to reach the maximum frame length.

11. The device of claim 1, wherein said transmitter transmits the segments making up a particular data packet in order.

12. The device of claim 1, wherein said transmitter interleaves segments associated with different data packets.

13. The device of claim 1, further comprising a striper to stripe the frame across a plurality of channels.

14. The device of claim 1, further comprising a switch fabric to provide a configurable connection between a plurality of sources and a plurality of destinations, wherein said switch fabric is configured by said scheduler, and wherein said switch fabric transmits frames from at least a subset of the plurality of sources to at least a subset of the plurality of destinations during a schedule cycle.

15. A method comprising:
receiving data packets of variable size;
forming segments from the received data packets, wherein the data packets received having a length greater than a maximum segment length are divided into multiple segments;
storing the segments in queues, wherein the queues are associated with destinations;
selecting a data path from at least one queue to an associated destination;
aggregating a plurality of segments to form a frame, wherein the frame has a maximum frame length, wherein the segments are retrieved from the at least one queue, and wherein the frame may contain segments associated with different data packets;
transmitting the frame to the associated destination, wherein the segments within the frame are transmitted together.

16. The method of claim 15, wherein said forming segments includes dividing the data packets having a length greater than the maximum segment length into at least a first segment having the maximum segment length, and wherein a last segment formed may be less than the maximum segment size.

17. The method of claim 15, wherein said aggregating includes aggregating complete segments.

18. The method of claim 15, wherein said transmitting includes striping the frame across a plurality of channels.

19. An apparatus comprising
a plurality of sources;
a plurality of destinations;
a receiver to receive frames, wherein the frames include a plurality of segments and the segments may be associated with multiple data packets;
a deframer to extract the segments from the frame;
a queue to store the segments;
a state monitor to track complete packets contained within the queue;
a reassembly unit to combine the segments making up a complete packet together to generate the packet;
a scheduler to generate a schedule for transmitting frames; and
a switch fabric to selectively connect the plurality of sources to the plurality of destinations based on the schedule, wherein said switch fabric transmits frames from at least a subset of the plurality of sources to at least a subset of the plurality of destinations.

20. The apparatus of claim 19, wherein the frames are striped over a plurality of channels and said receiver is a deskewer that receives the frame over the plurality of channels and deskews the stripes and combines them into the frame.

21. The apparatus of claim 19, further comprising an error checker to check for errors in the frame.

22. The apparatus of claim 21, wherein said error checker checks for errors by comparing a grant received to the frame.

23. The apparatus of claim 19, wherein said state monitor determines complete packets by detecting an end of packet.

24. A method comprising
receiving frames of data from a plurality of sources for a plurality of destinations over a switch fabric, wherein a frame includes a plurality of segments and wherein the segments may be associated with multiple data packets;
extracting the segments from the frame;
storing the segments in a queue;
monitoring complete packets contained within the queue; and
combining the segments making up a complete packet together to generate the packet.

25. The method of claim 24, further comprising checking for errors in the frame.

26. The method of claim 24, wherein said monitoring includes detecting an end of packet.

27. A store and forward device comprising
a plurality of Ethernet cards to receive data from and transmit data to external sources, wherein the plurality of Ethernet cards include
an ingress interface module to receive packets of variable size, store the packets as segments in queues associated with at least some subset of destination and priority, aggregate multiple segments together to form a frame, and transmit the segments within the frame together, wherein the segments stored in the queues have a segment maximum size and the packets having a larger size are divided into multiple segments, and wherein the frames have a maximum frame size, include a plurality of segments and may include segments associated with different packets, and
an egress interface module to receive frames, divide the frames into segments, store the segments in a queue, monitor the queues for complete packets, and reassemble a packet after the segments making up the packet are received;
a switching matrix to provide selective connectivity between said Ethernet cards;
a backplane consisting of a plurality of channels to connect said plurality of Ethernet cards to said switching matrix; and
a scheduler to select connectivity between Ethernet cards and to configure said switching matrix accordingly.

28. The device of claim 27, wherein said backplane also connects said plurality of Ethernet cards to said scheduler.

29. The device of claim 28, wherein said backplane uses same channels to connect said Ethernet cards to said switching matrix and to said scheduler.

30. The device of claim 28, wherein said backplane provides a logical separation of data path between said Ethernet cards and said switching matrix and scheduling path between said Ethernet cards and said scheduler.

31. The device of claim 27, wherein the maximum frame size is selected based on at least some subset of configuration time of data path, scheduling time for scheduler, and complexity of scheduling algorithms.

32. The device of claim 27, wherein the backplane is optical.

33. The device of claim 27, wherein the switching matrix is optical.

34. A store and forward device comprising
a plurality of ingress interface modules to receive packets of variable size, store the packets as segments in queues, aggregate multiple segments together to form a frame, and transmit the segments within the frame together, wherein the segments stored in the queues have a segment maximum size and the packets having a larger size are divided into multiple segments, and wherein the frames have a maximum frame size and include a plurality of whole segments and may include segments associated with different packets;
a plurality of egress interface modules to receive frames, divide the frames into segments, store the segments in queues, monitor the queues for complete packets, and reassemble a packet after the segments making up the packet are received;
a switching matrix to provide selective connectivity between said plurality of ingress interface modules and said plurality of egress interface modules;
a backplane consisting of a plurality of channels to connect said plurality of ingress interface modules and said plurality of egress interface modules to said switching matrix; and
a scheduler to select connectivity between said plurality of ingress interface modules and said plurality of egress interface modules, and to configure said switching matrix accordingly.

35. The device of claim 34, wherein a pipeline schedule is implemented that includes at least some subset of
said ingress interface modules forming and transmitting requests to said scheduler,
scheduler computing a schedule based on the requests,
said scheduler transmitting grants to associated ingress interface modules and configuring said switching matrix, and
said ingress interface modules transmitting the frames in response to the grants.

36. The device of claim 34, wherein said switching matrix extracts a clock from frames received, re-times the frames to a common internal clock domain, aligns any configuration changes provided by said scheduler to the boundaries of the frames, and maintains an uninterrupted data stream to the egress interface modules by transmitting an idle stream when no frames are being transmitted.
